(19) United States
(12) Patent Application Publication
(10) Pub. No.: US 2023/0135133 A1
(43) Pub. Date: May 4, 2023

(54) MASK

(71) Applicant: LG ELECTRONICS INC., Seoul (KR)

(72) Inventors: Taejun KIM, Seoul (KR); Jeongtaek PARK, Seoul (KR); Seokho CHOI, Seoul (KR)

(21) Appl. No.: 17/910,471

(22) PCT Filed: Mar. 9, 2021
(86) PCT No.: PCT/KR2021/002911

§ 371 Date: Sep. 9, 2022

(30) Foreign Application Priority Data
Mar. 11, 2020 (KR) 10-2020-0030239

(51) Int. Cl. A62B 18/02; A62B 23/02; A62B 18/00

(52) U.S. Cl. CPC A62B 18/025; A62B 23/02; A62B 18/006

(57) ABSTRACT

The present disclosure relates to a mask including: a mask main body being pressed against a face of a user, and forming an internal space for receiving air in front of a nose and a mouth of the user; and an air purifying module mounted in the mask main body, and having a first passage for allowing outside air to flow in a direction perpendicular to a side surface of the air purifying module, while forcing the air to flow into the nose and mouth of the user, in which by providing a first passage, a non-uniform suction flow may be reduced, such that an area of a filter may be used efficiently, and noise may be reduced.

### TECHNICAL FIELD

The following description relates to a mask having a fan, and more particularly to a mask having an air purifying module for uniformly passing air through a filter.

### BACKGROUND ART

Air pollution increases due to rapid industrialization and increased exhaust gas emissions from vehicles and the like. Pollutants (hereinafter referred to as foreign matter) causing such air pollution may lead to respiratory and heart diseases.

Particularly, fine dust and yellow dust, penetrating into the respiratory system of the human body and causing various diseases and the like, have a fatal adverse effect on people's lives today.

The fine dust is invisibly thin and tiny dust, and contains sulfur dioxide, nitrogen oxide, lead, ozone, carbon monoxide, and the like, as well as various air pollutants. Causes of the emissions may be divided into artificial emissions from vehicles or factories, and natural emissions from yellow dust caused by sandstorms, or dust caused by volcanic ash, forest fire, and the like. When inhaled by people, the fine dust penetrates deep into pulmonary alveoli, to cause various respiratory diseases, asthma, headache, atopy, etc., and particularly when inhaled continuously by the old and the infirm, the fine dust may lower their immune function, leading to death from lung diseases.

For this reason, there has been an increasing demand recently for protective equipment (e.g., medical mask) for filtering out foreign matter from the air. Such protective equipment generally includes a mask main body, a filter accommodated in the mask main body and covering the mouth and nose, and ear loops provided for the mask main body. By wearing the protective equipment, a user may protect the respiratory system from foreign matter in the air.

In a general case, as a filter performance for filtering out foreign matter is improved, a greater lung capacity is required for breathing. Accordingly, a problem occurs in that inconvenience of a mask wearer's breathing is caused in proportion to the filter performance for filtering out foreign matter.

In order to solve the above problem, Korean Registered Patent No. 10-1783804 (registered on Sep. 26, 2017) discloses a “mask with an air purifying filter device attached thereto,” which includes a mask main body, a filter accommodated in the mask main body, and a blower fan allowing air to flow into the mask main body.

However, the mask disclosed in the related art has a problem in that an air volume of the blower fan decreases due to resistance of the filter. As a method to overcome such problem, masks that are currently available in the market suggest a method of rotating a fan at a high RPM or a method of applying a porous passage or increasing a suction area to optimize the passage.

However, if the fan rotates at a high RPM while a gap between the fan and the filter is narrowed to reduce the volume of the mask, a problem occurs in that the entire area of the filter may not be used efficiently due to a non-uniform air flow. It is inefficient in that the flow is concentrated at an end portion of the fan, such that the edge of the filter is intensively used.

Furthermore, several problems also occur even when a guide vane 11 of FIG. 1A or a porous passage 12 of FIG. 1B is applied in order to optimize the passage. First, in the case of the porous passage 12, turbulence noise may be generated due to a non-uniform suction flow. Further, as air is introduced through a large number of holes, the inflow of air is limited. In the case where a suction area is increased using the guide vane 11, a flow rate may increase, but noise reduction effect may not be produced as the suction area is expanded.

Accordingly, there is a need to develop a mask allowing a uniform suction flow through a fan, without applying the guide vane 11 or the porous passage 12.

### PRIOR ART DOCUMENT

### Patent Document

Korean Registered Patent No. 10-1783804 (Sep. 26, 2017)

### DISCLOSURE OF INVENTION

### Technical Problem

It is an object of the present disclosure to provide a mask generating a uniform suction flow even when a fan rotates at a high rpm.

In addition, it is another object of the present disclosure to provide a mask having a fan but having a reduced volume.

Further, it is yet another object of the present disclosure to provide a mask having a fan but generating less noise.

The objects of the present disclosure are not limited to the aforementioned objects, and other objects not described herein will be clearly understood by those skilled in the art from the following description.

### Solution to Problem

In accordance with an aspect of the present disclosure, the above and other objects can be accomplished by providing a mask, including: a mask main body forming an internal space for receiving air in front of a nose and a mouth of the user, and having an inlet providing a passage for outside air to flow into the internal space; and an air purifying module mounted in the mask main body, and having a first passage for allowing the outside air to flow in a direction perpendicular to a side surface of the air purifying module.

Further, the mask according to the present disclosure may include the air purifying module, including: a case forming an exterior of the air purifying module; a cover covering a portion of the case; a filter disposed inside the case and filtering air introduced from an outside; and a fan disposed inside the case and provided on an inside of the filter.

The case may include a connection part inclined downwardly toward a center line of the mask main body from one surface of the case, and connected to the inlet of the mask main body.

The connection part may have a second passage formed therein, through which the outside air having passed through the filter and the fan may flow into the internal space.

The cover may include a curved surface portion having a convex curvature outwardly of the cover, wherein a distance between the cover and the filter may be largest at a center of the curved surface portion.

An air pocket may be formed between the curved surface portion and the filter, the air pocket being formed as a space for the outside air introduced through the first passage to flow along the curved surface portion.

In addition, the cover may include a flat surface portion extending in a direction parallel to the filter from an edge of the curved surface portion, and may further include a protrusion protruding inwardly of the cover from the flat surface portion, and coupled to the case to fix the cover.

A first direction length of the protrusion may be shorter than a first direction length of the cover.

Further, the case may include a recess receiving the protrusion, wherein a second direction length of the protrusion may be longer than a depth of the recess.

In accordance with another aspect of the present disclosure, the above and other objects can be accomplished by providing a mask, including: a mask main body forming an internal space for receiving air in front of a nose and a mouth of the user, and having a first inlet and a second inlet providing passages for outside air to flow into the internal space; a first air purifying module mounted on one side of the mask main body, and having a la passage for allowing the outside air to flow in a direction perpendicular to a side surface of the air purifying module; and a second air purifying module mounted on the other side of the mask main body, and having a 1b passage for allowing the outside air to flow in a direction perpendicular to a side surface of the air purifying module.

In addition, the mask according to the present disclosure may include the second air purifying module which is bilaterally symmetrical to the first air purifying module with respect to a center line of the mask main body.

Other detailed matters of the exemplary embodiments are included in the detailed description and the drawings.

### Advantageous Effects of Invention

The mask according to the present disclosure has one or more of the following effects.

First, as air is sucked through the first passage formed in a direction perpendicular to a side surface, noise caused when the air is sucked may be reduced.

Second, a cover has a curved surface portion such that an air pocket, formed as a space for an air flow, may be formed between the cover and the filter, thereby allowing a uniform flow of the sucked air.

Third, by overcoming a non-uniform suction flow, pressure between the cover and the filter may be reduced.

Fourth, as a result, an area of the filter may be used efficiently, thereby improving durability of the filter.

Fifth, even when a thin fan is used, the fan may rotate at a high rpm, such that a volume of the air purifying module may be reduced.

The effects of the present disclosure are not limited to the aforesaid, and other effects not described herein will be clearly understood by those skilled in the art from the following description of the appended claims.

### BRIEF DESCRIPTION OF DRAWINGS

FIGS. 1A and 1B are diagrams illustrating a general mask.

FIG. 2 is a diagram illustrating a mask according to an embodiment of the present disclosure.

FIG. 3 is a diagram illustrating a mask main body according to an embodiment of the present disclosure.

FIG. 4 is a cross-sectional view of an air purifying module according to an embodiment of the present disclosure.

FIGS. 5A and 5B are diagrams illustrating a cover applied to a mask according to an embodiment of the present disclosure.

FIG. 6 is a diagram illustrating a cover according to another embodiment of the present disclosure.

FIG. 7 is a diagram illustrating an example of forming an air pocket according to an embodiment of the present disclosure.

FIGS. 8A to 8D are diagrams illustrating a flow of air during breathing according to an embodiment of the present disclosure.

FIG. 9 is a diagram illustrating a noise reduction effect according to an embodiment of the present disclosure.

### BEST MODE FOR CARRYING OUT THE INVENTION

Advantages and features of the present disclosure and methods for accomplishing the same will be more clearly understood from exemplary embodiments described below with reference to the accompanying drawings. However, the present disclosure is not limited to the following embodiments but may be implemented in various different forms. The embodiments are provided only to complete disclosure of the present disclosure and to fully provide a person having ordinary skill in the art to which the present disclosure pertains with the category of the present disclosure, and the present disclosure will be defined by the scope of the appended claims. Wherever possible, the same reference numbers will be used throughout the drawings to refer to the same or like parts.

Spatially-relative terms such as “below”, “beneath”, “lower”, “above”, or “upper” may be used herein to describe one element's relationship to another element as illustrated in the Figures. It will be understood that spatially-relative terms are intended to encompass different orientations of the device in addition to the orientation depicted in the Figures. For example, if the device in one of the figures is turned over, elements described as “below” or “beneath” other elements would then be oriented “above” the other elements. The exemplary terms “below” or “beneath” can, therefore, encompass both an orientation of above and below. Since the device may be oriented in another direction, the spatially-relative terms may be interpreted in accordance with the orientation of the device.

The terminology used in the present disclosure is for the purpose of describing particular embodiments only and is not intended to limit the disclosure. As used in the disclosure and the appended claims, the singular forms are intended to include the plural forms as well, unless context clearly indicates otherwise. It will be further understood that the terms “comprises” and/or “comprising,” when used in this specification, specify the presence of stated components, steps, and/or operations, but do not preclude the presence or addition of one or more other components, steps, and/or operations thereof.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms are intended to include the plural forms as well, unless the context clearly indicates otherwise.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, the thickness or size of each constituent element is exaggerated, omitted, or schematically illustrated for convenience of description and clarity. Also, the size or area of each constituent element does not entirely reflect the actual size thereof.

In general, a suffix such as “module” and “unit” used to refer to elements or components in the following description is merely intended to facilitate description of the specification, and the suffix itself is not intended to give any special meaning or function.

Hereinafter, preferred embodiments of the present disclosure will be described with reference to the accompanying drawings.

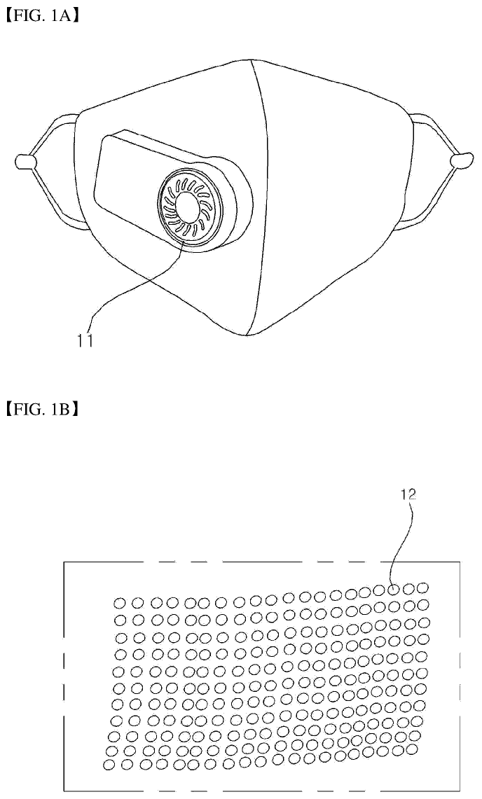

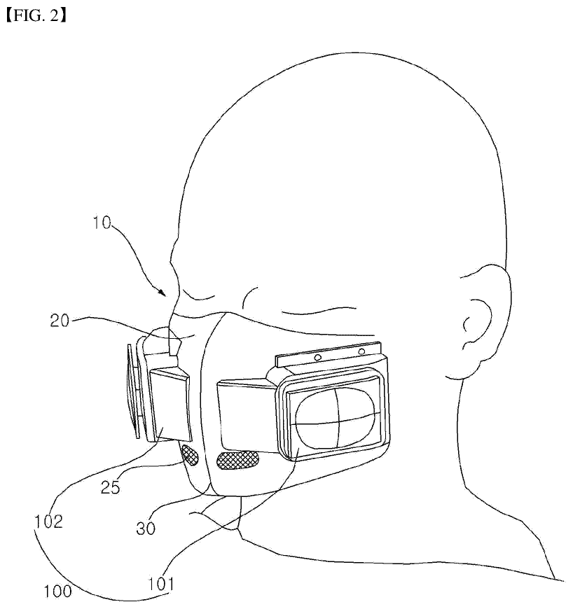

FIGS. 1A and 1B are diagrams illustrating a general mask.

As described above, the guide vane 11 of FIG. 1A or the porous passage 12 of FIG. 1B are applied to the general mask in an attempt to optimize a flow passage, but the general mask still has a problem in that turbulence noise is generated due to a non-uniform suction flow.

Accordingly, a mask 10 according to an embodiment of the present disclosure may include an air purifying module 100 allowing for a uniform suction flow, without applying the guide vane 11 or the porous passage 12.

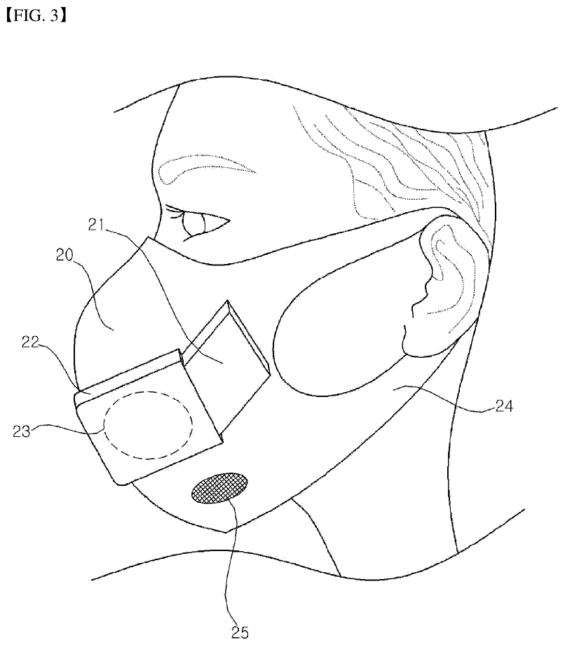

FIG. 2 is a diagram illustrating a mask according to an embodiment of the present disclosure.

Referring to FIG. 2, the mask 10 may include a mask main body 20 pressed against a user's face, and the air purifying module 100 mounted in the mask main body 20.

The mask main body 20 may be pressed against a user's face to form an internal space for receiving air in front of the user's nose and mouth. The mask main body 20 may have an inlet 22 providing a passage through which outside air may flow into the internal space. Further, the mask main body 20 may have a mounting part 21 on which the air purifying module 100 is mounted. The mask main body 20 may have a discharge part 25 providing a passage through which internal air may be discharged to the outside.

The inlet 22 may have one or more holes 23. Air having passed through the air purifying module 100 may flow into the internal space through the one or more holes 23. The discharge part 25 may be disposed below the inlet 22. The discharge part 25 may discharge the internal air to the outside by allowing the air to flow in one direction.

There may be one or more discharge parts 25. The discharge part 25 may allow air to flow in one direction. That is, the discharge part 25 may discharge the air inside the mask main body 20 to an external space. However, the outside air may not flow into the internal space of the mask main body 20 through the discharge part 25. For example, a check valve may be provided for the discharge part 25.

The air purifying module 100 may force the outside air to flow into the user's nose sand mouth. In this case, the air purifying module 100 may force the outside air to flow in a direction perpendicular to a side surface of the air purifying module 100. The air purifying module 100 may have a first passage for the flow of air.

There may be one or more air purifying modules 100.

In the case where there is one air purifying module 100, the air purifying module 100 may be mounted on one side of the mask main body 20, and the one side of the mask main body 20 may be the left side or the right side of a user's face when the user wears the mask 10.

In the case where there are two air purifying modules 100, the air purifying modules 100 may include a first air purifying module 101 mounted on one side of the mask main body 20, and a second air purifying module 102 mounted on the other side of the mask main body 20. In this case, the one side of the mask main body 20 may be the left side or the right side of the user's face when the user wears the mask 10. The other side of the mask main body 20 may be the right side or the left side of the user's face when the user wears the mask 10.

In the case where there are two air purifying modules 100, the mask main body 20 may include a first inlet and a second inlet providing passages for the outside air to flow into the internal space. Air filtered by the first air purifying module 101 may flow into the internal space through the first inlet. Air filtered by the second air purifying module 102 may flow into the internal space through the second inlet.

The mask main body 20 may have a first discharge part disposed below the first inlet. The mask main body 20 may have a second discharge part disposed below the second inlet. The first discharge part and the second discharge part may discharge the internal air to the external space by allowing the air to flow in one direction. That is, when the user exhales, the internal air may be discharged to the outside through at least either the first discharge part or the second discharge part.

The first air purifying module 101 may have a la passage for allowing air to flow in a direction perpendicular to the side surface while forcing the outside air to flow into the user's nose and mouth.

The following description of the air purifying module 100 may be applied to the first air purifying module 101. That is, each component including a cover 110, a filter 120, a fan 130, and a case 140, which will be described later, and sub-components thereof may be understood as a first cover, a first filter, a first fan, a first case, and sub-components thereof.

The second air purifying module 102 may have a 1b passage for allowing air to flow in a direction perpendicular to the side surface while forcing the outside air to flow into the user's nose and mouth.

The second air purifying module 102 may include a second cover, a second filter, a second fan, a second case, and sub-components thereof, which correspond to the first cover, the first filter, the first fan, the first case, and the sub-components thereof.

The second air purifying module 102 may be bilaterally symmetrical to the first air purifying module 101 with respect to a central line 30 of the mask main body 20. That is, the second cover, the second filter, the second fan, the second case, and the sub-components thereof may be bilaterally symmetrical to the first cover, the first filter, the first fan, the first case, and the sub-components thereof with respect to the center line 30.

Hereinafter, a description of the second cover, the second filter, the second fan, the second case, and the sub-components thereof will be omitted, but may be easily understood by those skilled in the art, since the role and function thereof are the same as the cover 110, the filter 120, the fan 130, the case 140, and the sub-components thereof which will be described later.

FIG. 3 is a diagram illustrating a mask main body according to an embodiment of the present disclosure.

Referring to FIG. 3, the mask main body 20 may include a mounting part 21, an inlet 22, and a discharge part 25.

The mask main body 20 may be coupled to the air purifying module 100 via the mounting part 21. The air purifying module 100 may be mounted in the mounting part 21. Specifically, the air purifying module 100 may include the case 140, and a lower end of the case 140 may be mounted in the mounting part 21.

The inlet 22 may be provided on a side surface toward the center line 30 of the mounting part 21. That is, when the mounting part 21 is located on a right side surface of the mask main body 20, the inlet 22 may be formed on a left side surface of the mounting part 21. Further, when the mounting part 21 is located on a left side surface of the mask main body 20, the inlet 22 may be formed on a right side surface of the mounting part 21.

The mask main body 20 may be coupled to the air purifying module 100 via the inlet 22. A portion of the air purifying module 100 may be mounted in the inlet 22. Specifically, the air purifying module 100 has a connection part 145, and one surface of the connection part 145 may be mounted in the inlet 22.

In addition, the other surface of the connection part 145 may come into contact with the case 140, such that the connection part 145 may connect the case 140 and the inlet 22.

The inlet 22 may have one or more holes 22. Referring to FIG. 3, it is illustrated that there is one hole 23, but the hole 23 is not limited thereto, and the inlet 22 may have a plurality of holes.

The hole 23 may form a second passage through which the filtered air may flow into the internal space of the mask main body 20. The second passage may refer to a passage through which air, having passed through the fan 130, passes through the case 140 and the internal space of the connection part 140 to reach the hole 23. In this case, the size of the hole 23 may be smaller than the size of the inlet 22.

The discharge part 25 may be disposed below the inlet 22. The position of the discharge part 25 may correspond to the user's nose or mouth. That is, the discharge part 25, which is disposed below the inlet 22, may effectively discharge air, exhaled by the user, to the external space.

The discharge part 25 may discharge the internal air to the external space by allowing the air to flow in one direction. To this end, a check valve may be provided for the discharge part 25. The check valve opens when the internal air is discharged to the external space, and shuts when the outside air flows into the internal space.

In other words, when the user inhales, the check value shuts such that the outside air is introduced through the air purifying module 100; and when the user exhales, the check value opens such that the internal air may be discharged to the external space through the discharge part 25.

The mask main body 20 may further include ear loops 24. The mask main body 20 may include the ear loops 24 formed on both sides of the mask main body 20 to be hung on the user's ears. The ear loops 24 may fix the mask main body 20 by allowing the mask main body 20 to be pressed against the user's face.

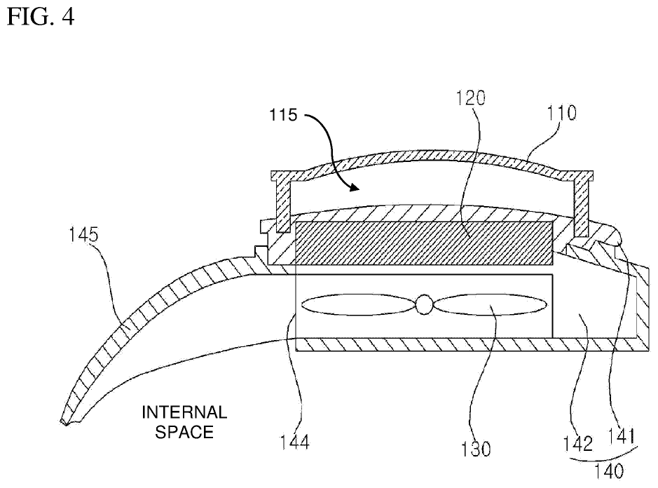

FIG. 4 is a cross-sectional view of an air purifying module according to an embodiment of the present disclosure.

Referring to FIG. 4, the air purifying module 100 may include the case 140 forming the exterior of the air purifying module 100, the cover 110 covering a portion of the case 140, the filter 120 filtering air introduced from the outside, and the fan 130 disposed in the case 140 and formed on the inside of the filter 120.

In the following description, the inside indicates a direction of a user's face or a direction of the internal space formed by a mask when the user wears the mask, and the outside indicates a direction a direction opposite to the user's face or a direction of the external space.

The case 140 may form the exterior of the air purifying module 100, and may have one open surface. The fan 130 and the filter 120 may be stacked through the open surface of the case 140.

The cover 110 may cover a portion of the case 140. Specifically, the cover 110 may be disposed to cover the open surface of the case 140. The cover 110 may have a curved surface portion 111 having a convex curvature outwardly of the cover 110, and a flat surface portion 112 extending in a direction parallel to the filter 120 from an edge of the curved surface portion 111.

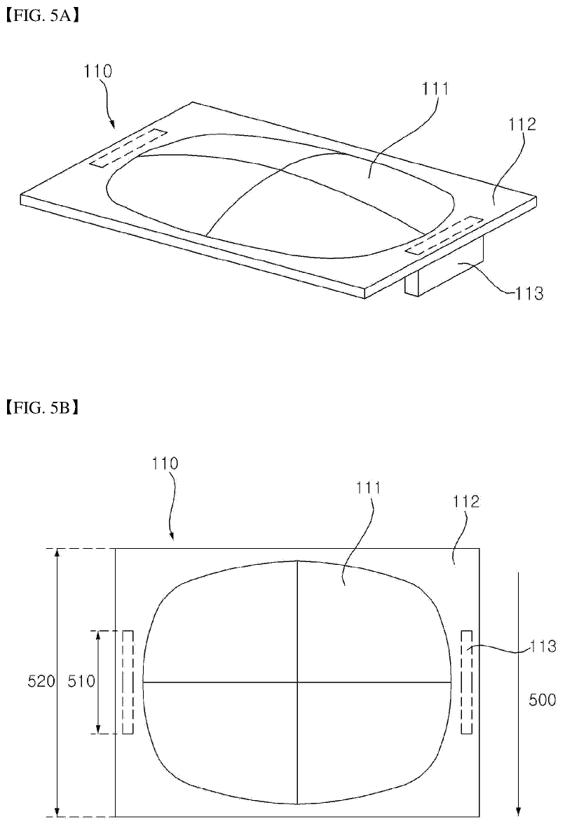

A detailed description of the cover 110 will be given later with reference to FIGS. 5A and 5B.

The filter 120 may be disposed inside the case 140 to be fixed to the case 140. The filter 120 may filter out foreign matter from air flowing through the first passage. The filter 120 may have a filter member for filtering out foreign matter. For example, the filter member may include a mesh filter in the form of a mesh, an electrostatic filter filtering out foreign matter using static electricity, and the like.

The filter 120 may be detachably mounted in the case 140. Accordingly, when the filter 120 is contaminated, a user may replace the contaminated filter 120.

The fan 130 may be disposed on the inside the filter 120.

The fan 130, disposed inside the case 140, may draw in air having passed through the filter 120. Although not illustrated herein, the fan 130 may include a fan motor. The fan motor may be a motor for driving rotation of the fan 130. That is, when the fan 130 is rotated by the operation of the fan motor, outside air may be introduced by the fan 130. Further, depending on embodiments, the fan motor may drive the fan 130 to rotate to discharge exhaled air.

A thickness of the fan 130 may be less than a reference thickness. In addition, a speed of rotation of the fan 130 may be faster than a reference speed of rotation so as to overcome a flow resistance of the filter 120. For example, the reference speed of rotation may be 8,000 rpm. A distance between the fan 130 and the filter 120 may be smaller than a reference distance.

If the speed of rotation of the fan 130 is fast but the distance between the fan 130 and the filter 120 is small, a flow velocity of air drawn in through the fan 130 may be concentrated at a specific portion. That is, the entire area of the filter 120 may not be used effectively. However, the problem may be overcome by providing an air pocket according to an embodiment of the present disclosure between the filter 120 and the cover 110.

The fan 130 may be a centrifugal type fan. That is, the fan 130 may draw in air, filtered by the filter 120, in a direction perpendicular to the fan 130, and may discharge the air in a radial direction of the fan 130. The connection part 145 is disposed radially of the fan 130, and the air discharged from the fan 130 may flow into the internal space of the mask 10 through the connection part 145. By using such centrifugal type fan, the thickness of the fan 130 may be reduced, thereby reducing the thickness of the case 140, as well as the thickness and weight of the air purifying module 100.

The case 140 may include a first case 141 having the filter 120, a second case 142 having the fan 130, and the connection part 145 connecting the second case 142 and the mask main body 20.

The filter 120 may be disposed inside the first case 141, and the first case 141 may fix the filter 120. A recess 143 may be formed in the first case 141, and the cover 110 may be fixed or supported in the recess 143.

The fan 130 may be disposed inside the second case 142, and the second case 142 may fix the fan 130. A connection hole 144 is formed on one surface of the second case 142, and the second case 142 may be connected to the connection part 145 through the connection hole 144.

The following description will be given without distinguishing the first case 141 and the second case 142, but the following description of the case 140 may be applied to both the first case 141 and the second case 142.

The connection part 145 may be inclined downwardly toward the center line 30 of the mask main body 20 from one surface of the case 140. Referring to FIG. 4, it is illustrated that the connection part 145 is a curved surface and is inclined downwardly, but is not limited thereto. That is, the connection part 145 may be a flat surface and may be inclined downwardly.

The connection part 145 may be connected to the inlet 22 of the mask main body 20.

The connection hole 144 may be formed on one surface of the second case 142. Air, having passed through the fan 140, may flow into the connection part 145 through the connection hole 144. The connection part 145 may have a second passage formed therein, through which outside air, having passed through the filter 120 and the fan 130, flows into the mask main body 20.

To sum up, the air having passed through the filter 120 is introduced into the fan 130 in a direction perpendicular to the fan 130 and is discharged in the radial direction of the fan 130, to flow into the internal space of the mask main body 20 through the second passage connecting the connection hole 144, the internal space of the connection part 145, and the hole 23 of the inlet 22.

In the mask 10 according to an embodiment of the present disclosure, the connection part 145 is formed toward the center line 30, such that the air filtered by the filter 120 may be concentrated on a user's mouth and nose. That is, the second passage may guide a flow of the filtered air to be concentrated on the user, thereby improving user-friendliness.

FIGS. 5A and 5B are diagrams illustrating a cover applied to a mask according to an embodiment of the present disclosure.

FIG. 5A is a perspective view of the cover 110, and FIG. 5B is a top view of the cover 110.

Referring to FIGS. 5A and 5B, the cover 110 may have a curved surface portion 111 having a convex curvature outwardly of the cover 110, and a flat surface portion 112 extending in a direction parallel to the filter 120 from an edge of the curved surface portion 111. In addition, the cover 110 may further include a protrusion 113 which protrudes inwardly of the cover 110 from the flat surface portion 112, to be coupled to the case 140 to fix the cover 110.

The cover 110 may be disposed to cover the open surface of the case 140, and may be spaced apart from the case 140 by a predetermined distance. The fan 130 and the filter 120 are sequentially stacked inside the case 140, and thus the cover 110 may be spaced apart from the filter 120. As the cover 110 and the filter 120 are spaced apart from each other, an air pocket may be formed as a space between the cover 110 and the filter 120.

The curved surface portion 111, formed as a portion of the cover 110, may have a curvature outwardly of the cover 110. A distance between the cover 110 and the filter 120 may increase with the curved surface portion 111. That is, the air pocket, which is a space between the cover 110 and the filter 120, may be formed wide by the curved surface portion 111. Further, the filter 120 may uniformly draw in air through the air pocket.

The flat surface portion 112 may be a portion of the cover 110 except the curved surface portion 111. The flat surface portion 112 may have the protrusion 113. The protrusion 113, which is coupled to the case 140 to fix the cover 110, is formed on the flat surface portion 112 rather than on the curved surface portion 111, thereby stably fixing the cover 110.

The cover 110 may be detachably coupled to the case 140 by the protrusion 113. A user may detach the cover 110 to replace the filter 120, and when the cover 110 is attached, the cover 110 may be fixed to the case 140. In addition, the protrusion 113 may support the cover 110.

Referring to FIG. 5A, the cover 110 may be spaced apart from the case 140 by the protrusion 113, and the outside air may flow into the case 140 through the separated space. As illustrated herein, when the cover 110 has a rectangular shape, the outside air may be introduced from all four sides, i.e., top, bottom, left, and right sides, of the cover 110.

The four sides of the cover 110 may refer to lateral surfaces of the air purifying module 100. That is, the outside air may flow into the air purifying module 100 through the lateral surfaces. In this case, the outside air may flow into the air purifying module 100 through the first passage. The first passage may refer to a path through which the outside air may flow into the air purifying module 100.

Specifically, the outside air may be introduced in a direction perpendicular to the lateral surface of the case 140 forming the exterior of the air purifying module 100. The lateral surface of the case 140 may be the same as the lateral surface of the air purifying module 100. Accordingly, as the case 140 and the cover 110 are spaced apart from each other, the first passage may be formed for the flow of air in a direction perpendicular to the lateral surface of the air purifying module 100.

As the air flows through the first passage, the first passage may reduce noise caused by the air flow. Further, the first passage provides a wider suction area than a porous passage, thereby reducing a flow rate loss and a pressure loss.

Referring to FIG. 5B, a first direction 500 may refer to a lengthwise direction (up-down direction of FIG. 5B) of the cover 110. A first direction length 510 of the protrusion 113 may be shorter than a first direction length 520 of the cover 110. If the first direction length 510 of the protrusion 113 is equal to or longer than the first direction length 520 of the cover 110, the flow of air in a left-right direction of the cover 110 may be blocked.

Accordingly, the first direction length 510 of the protrusion 113, which is shorter than the first direction length 520 of the cover 110, may allow the air purifying module 100 to generate a flow on four top, bottom, left, and right sides of the cover 110, thereby enhancing air purification efficiency.

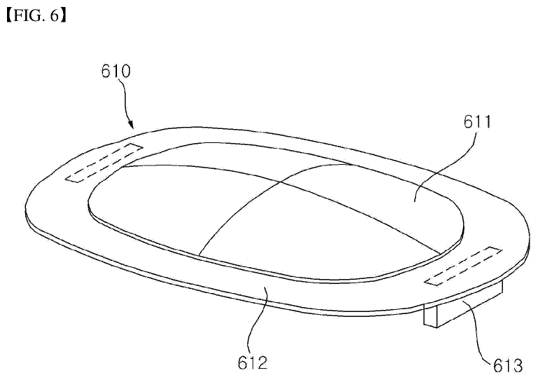

FIG. 6 is a diagram illustrating a cover according to another embodiment of the present disclosure.

Referring to FIG. 6, a cover 610 may have a circular shape. The circular cover 610 may have a curved surface portion 611 having a convex curvature outwardly of the cover 110, and a flat surface portion 612 extending in a direction parallel to the filter 120 from an edge of the curved surface portion 111. In addition, the cover 610 may further include a protrusion 613 which protrudes inwardly of the cover 610 from the flat surface portion 612, to be coupled to the case 140 to fix the cover 610.

The circular cover 610 of FIG. 6, which is different only in shape from the cover 110 of FIG. 5A, may perform the same function as the cover 110 of FIG. 5A. However, in the case of the circular cover 610, the air purifying module 100 may draw in outside air in all directions along the edge of the cover 610, thereby further improving air flow performance.

Accordingly, all of the descriptions of the cover 110 of FIG. 5A, except the description of the four top, bottom, left, and right sides of the cover 110, may be applied to the circular cover 610 of FIG. 6.

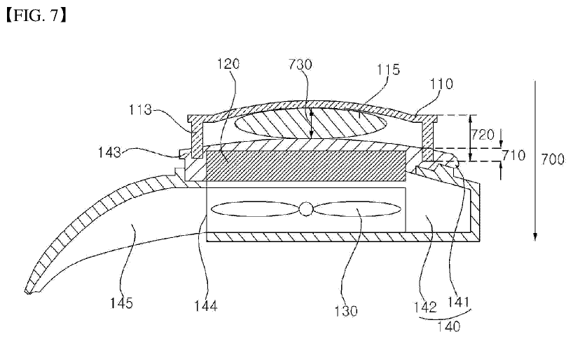

FIG. 7 is a diagram illustrating an example of forming an air pocket according to an embodiment of the present disclosure.

Referring to FIG. 7, as the cover 110 and the filter 120 are spaced apart from each other, the air pocket 115 may be formed in a space between the cover 110 and the filter 120.

The curved surface portion 111 may have a curvature outwardly of the cover 110. Accordingly, a distance between the cover 110 and the filter 120 may increase compared to a case where the cover has only the flat surface portion 112.

The distance between the cover 110 and the filter 120 may be largest at the center of the curved surface portion 111. That is, the air pocket 115, which is a space between the cover 110 and the filter 120, may be formed wide by the curved surface portion 111. The outside air is introduced into a narrow space between the flat surface portion 112 and the case 140, to reach the wide air pocket 115, such that pressure of the air may be reduced.

The outside air, introduced through the first passage, may flow along the curved surface portion 111 inside the air pocket 115 having a reduced pressure. While flowing along the curved surface portion 111, the outside air may spread uniformly inside the air pocket 115. The uniformly spread air may be introduced uniformly into the filter 120 by a suction force of the fan 130.

That is, as the cover 110, having the curved surface portion 111, and the filter 120 are spaced apart from each other, the air pocket 115 is formed between the cover 110 and the filter 120, and the outside air introduced into the air pocket 115 may spread uniformly inside the air pocket 115 along the curved surface portion 111. Accordingly, the filter 120 may uniformly draw in the outside air, and the entire area of the filter 120 may be used efficiently, thereby improving performance and durability of the filter 120.

In order to introduce large amounts of air into the air pocket 115, the cover 110 may be spaced apart from the case 140. The cover 110 has no porous passage, such that the air may flow through the first passage formed as a space between the cover 110 and the case 140. The cover 110 has the protrusion 113 and is supported by the protrusion 113, such that the cover 110 may be spaced apart from the case 140.

The case 140 may have the recess 143 in which the protrusion 113 is received. Specifically, the recess 143 may be formed in the first case 141. The protrusion 113 may be coupled to the recess 143. By receiving the protrusion 113, the recess 143 may fix the protrusion 113, such that the first case 141 may fix the cover 110.

Further, by receiving the protrusion 113, the recess 143 may support the cover 110. As the protrusion 113 is coupled to the recess 143, the protrusion 113 may support the cover 110. In this case, the cover 110 and the case 140 may be spaced apart from each other.

A second direction length 710 of the protrusion 113 may be longer than a depth 720 of the recess 143. A second direction 700 may refer to an inward direction (downward direction in FIG. 7). If the second direction length 710 of the protrusion 113 is equal to the depth of the recess 143, the cover 110 and the case 140 come into contact with each other, such that the first passage may not be formed or may be narrowed, thereby reducing a suction flow rate. Accordingly, in order to allow the cover 110 and the case 140 to be spaced apart from each other, the second direction length 710 of the protrusion 113 is formed to be longer than the depth 720 of the recess 143 by a predetermined value or more, thereby securing a sufficient first passage.

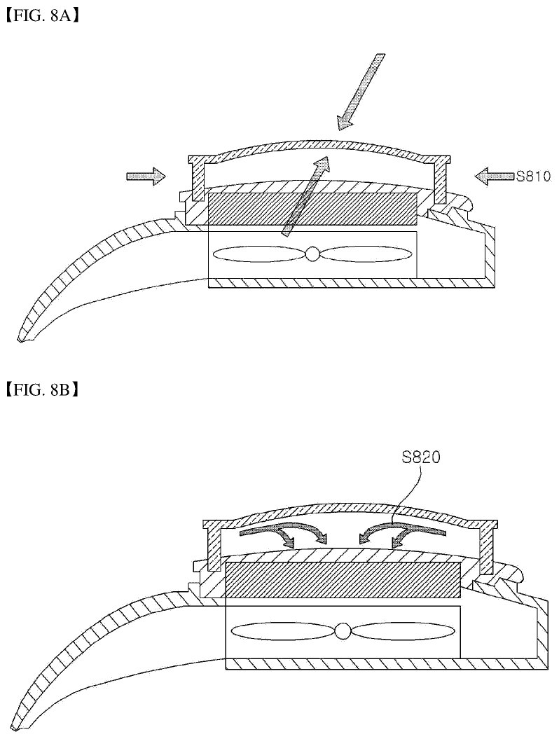

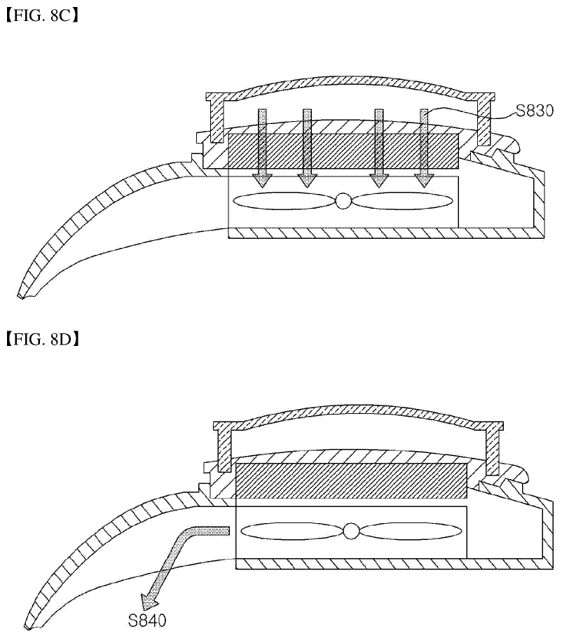

FIGS. 8A to 8D are diagrams illustrating a flow of air during breathing according to an embodiment of the present disclosure.

FIGS. 8A to 8D are diagrams explaining a moving path of air when a user inhales. When the user exhales, the air may be discharged to the outside through the discharge part 25 of FIGS. 2 and 3, although not illustrated separately.

Referring to FIGS. 8A to 8D, the following description will be given based on the flow of air during a user's inhalation.

Referring to FIG. 8A, the outside air may flow into the air purifying module 100 through the first passage formed between the cover 110 and the first case 141 (S810). The first passage may be formed perpendicular to the lateral surface of the air purifying module 100. A direction of the lateral surface of the air purifying module 100 may be equal to a direction of the lateral surface of the case 140 and a direction of the lateral surface of the cover 110.

If the air purifying module 100 has a circular shape, the first passage may be formed in a radial direction of the air purifying module 100. In this case, the outside air may be introduced in a forward direction, which is a direction perpendicular to the side of the air purifying module 100.

If the air purifying module 100 has a rectangular shape, the first passage may be formed in a direction perpendicular to four sides of top, bottom, left, and right of the lateral surface of the air purifying module 100. In this case, the outside air may be introduced in a direction perpendicular to the lateral surface of the air purifying module 100.

Referring to FIG. 8B, the outside air introduced through the first passage may spread uniformly inside the air pocket 115 (S820). The air pocket 115, formed as a space between the cover 110 and the filter 120, may be formed wide by the curved surface portion 111 of the cover 110. The outside air may spread uniformly along the curved surface portion 111 inside the air pocket 115 having a reduced pressure.

As the distance between the filter 120 and the fan 130 decreases, the volume and weight of the air purifying module 100 may be reduced. Accordingly, the distance between the filter 120 and the fan 130 may be formed to be equal to or less than a predetermined distance.

However, while the distance between the filter 120 and the fan 130 is equal to or less than a predetermined distance, if the fan 130 rotates at a high rpm equal to or higher than 8,000 rpm, a non-uniform air flow may be generated. The air pocket 115 may prevent such non-uniform air flow. That is, by reducing pressure between the cover 110 and the filter 120, the air pocket 115 may generate a uniform suction flow.

Referring to FIG. 8C, the outside air, spreading uniformly by the air pocket 115, may be uniformly drawn into the filter 120 and the fan 130 by the torque of the fan 130 (S830). Accordingly, the entire area of the filter 120 may be used uniformly, and performance and durability of the filter 120 may be improved.

The fan 130 may be a centrifugal type fan. The fan 130 may draw in air, having filtered by the filter 120, in a direction perpendicular to the fan 130, and may discharge the air in a radial direction of the fan 130. Specifically, the fan 130 may discharge the air toward the connection hole 144. By using the centrifugal type fan, a thickness of the fan 130 may be reduced, thereby reducing the thickness of the case 140, as well as the volume and weight of the air purifying module 100.

Referring to FIG. 8D, the air discharged in the radial direction of the fan 130 may flow into the internal space of the mask main body 20 through the second passage formed in the internal space of the connection part 145 (S840).

The connection part 145 may be disposed radially of the fan 130. Specifically, the connection part 145 may be inclined downwardly toward the center line 30 of the mask main body 20 from one surface of the case 140, and may be connected to the inlet 22 of the mask main body 20. The connection hole 144 may be formed on one surface of the case 140. Air having passed through the fan 130 may flow into the connection part 145 through the connection hole 144, and may flow into the internal space of the mask main body 20 through the hole 23 of the inlet 22.

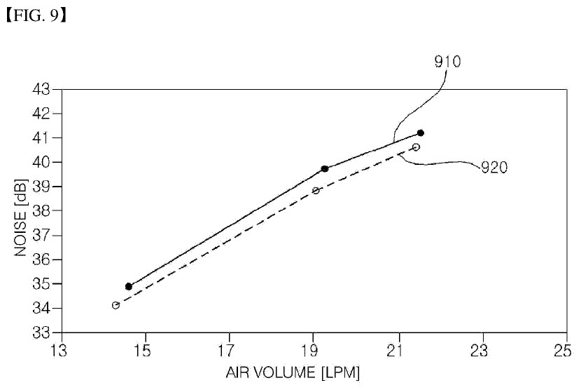

FIG. 9 is a diagram illustrating a noise reduction effect according to an embodiment of the present disclosure.

Referring to FIG. 9, the mask 10 according to an embodiment of the present disclosure has a noise reduction effect compared to a mask having a general fan.

By measuring noise (dB) with respect to air volume (LPM), it can be seen that a noise level of the mask 10 as shown in graph 920 is reduced, compared to the mask having the general fan as shown in graph 910. In the general mask, a porous passage is mostly applied in order to optimize a passage. In this case, a loud noise is generated by a non-uniform suction flow.

In the mask 10 according to an embodiment of the present disclosure, noise may be reduced while increasing a suction area through the first passage, without using the porous passage. Further, by providing the curved surface portion 111 on the cover 110, the air pocket 115 may be formed between the cover 110 and the filter 120.

Particularly, a largest gap is formed between the center of the cover 110 and the filter 120, and preferably a gap of 5 mm may be formed therebetween. By using the air pocket 115, a space for the flow of air may be further provided compared to the cover having a flat surface shape. In addition, the air pocket 115 may overcome the nonuniformity of the suction flow, and may provide a noise reduction effect as well as an effect of reducing pressure between the filter 120 and the cover 110.

While preferred embodiments of the present disclosure have been described and illustrated herein, the present disclosure is not limited to the specific embodiments described above. It should be understood that various modifications of the embodiments are possible by those skilled in the art without departing from the technical scope of the present disclosure defined by the appended claims, and the modifications should not be understood separately from the technical principles or prospects of the present disclosure.

1. A mask comprising:
a mask main body forming an internal space, and having an inlet providing a passage for outside air to flow into the internal space; and
an air purifying module mounted in the mask main body and to guide the outside air toward the inlet, the air purifying module having a first passage that guides the outside air to flow in a direction perpendicular to a front surface of the air purifying module.

2. The mask of claim 1, wherein the inlet has one or more holes, and air flows through the air purifying module and into the internal space through the one or more holes.

3. The mask of claim 1, wherein the mask main body has a discharge port positioned below the inlet, and
wherein the discharge part allows internal air to flow in one direction toward an external space.

4. The mask of claim 1, wherein the air purifying module includes:
a case that forms an exterior of the air purifying module;
a cover that covers a portion of the case;
a filter positioned inside the case and configured to filter the outside air; and
a fan positioned inside the case to receive filtered air from the filter.

5. The mask of claim 4, wherein the case includes a connection wall inclined toward a center line of the mask main body from one surface of the case, and connected to the inlet of the mask main body.

6. The mask of claim 5, wherein the connection wall defines a second passage through which the filtered air from the fan flows into the internal space.

7. The mask of claim 4, wherein the cover includes:
a curved surface region having an outwardly convex curvature; and
a flat surface region extending in a direction parallel to the filter from an edge of the curved surface region.

8. The mask of claim 7, wherein a distance between the cover and the filter is greatest at a center of the curved surface region.

9. The mask of claim 7, wherein an air pocket is formed between the curved surface region and the filter, the air pocket being formed as a space for the outside air introduced through the first passage to flow along the curved surface region.

10. The mask of claim 7, wherein the cover includes a protrusion protruding inwardly of the cover from the flat surface region and coupled to the case to fix the cover, and
wherein the cover is detachably coupled to the case by the protrusion.

11. The mask of claim 10, wherein a length of the protrusion along a lengthwise direction of the cover is less than a length of the cover along the lengthwise direction.

12. The mask of claim 10, wherein the case includes a recess receiving the protrusion, and
wherein a length of the protrusion in an inward direction is greater than a depth of the recess in the inward direction.

13. A mask comprising:
a mask main body forming an internal space, and having a first inlet and a second inlet providing passages for outside air to flow into the internal space;
a first air purifying module mounted on a first side of the mask main body, and having a first passage that guides the outside air to flow in a direction perpendicular to a front surface of the first air purifying module; and
a second air purifying module mounted on a second side of the mask main body, and having a first passage that guides the outside air to flow in a direction perpendicular to a front surface of the second air purifying module.

14. The mask of claim 13, wherein the second air purifying module is bilaterally symmetrical to the first air purifying module with respect to a center line of the mask main body.

15. The mask of claim 13, wherein the first air purifying module includes:
a first case that forms an exterior of the first air purifying module;
a first cover that covers a portion of the first case;
a first filter disposed inside the first case and is configured to filter the outside air; and
a first fan disposed inside the first case and positioned to receive the filtered air from the first filter.

16. The mask of claim 15, wherein the first case include, a first connection wall inclined toward the center line of the mask main body from one surface of the first case, and connected to the first inlet of the mask main body, and
wherein the first connection defines a second passage through which filtered air from the first fan flows into the internal space.

17. The mask of claim 15, wherein the first cover includes:
a first curved surface region having an outwardly convex curvature; and
a first flat surface region extending in a direction parallel to the first filter from an edge of the first curved surface region, and
wherein a distance between the first cover and the first filter is greatest at a center of the first curved surface region.

18. The mask of claim 17, wherein a first air pocket is formed between the first curved surface region and the first filter, the first air pocket being formed as a space for the outside air introduced through the first passage of the first air purifying module to flow along the first curved surface region.

19. The mask of claim 17, wherein the first cover includes a first protrusion protruding inwardly of the first cover from the first flat surface region, and coupled to the first case to fix the first cover, and
wherein a length of the first protrusion in a lengthwise direction of the first cover is less than a length of the first cover in the lengthwise direction.

20. The mask of claim 19, wherein the first case includes a first recess receiving the first protrusion, and
wherein a length of the first protrusion in an inward direction is greater than a depth of the first recess.
